(19) United States
(12) Patent Application Publication
(10) Pub. No.: US 2026/0008355 A1
(43) Pub. Date: Jan. 8, 2026

(54) TORQUE CONTROL SYSTEM AND METHOD FOR DRIVE SYSTEM OF ELECTRIC VEHICLE

(71) Applicants: Hyundai Motor Company, Seoul (KR); Kia Corporation, Seoul (KR)

(72) Inventors: Jiwon OH, Hwaseong-Si (KR); Jeong Soo Eo, Hwaseong-Si (KR); Ho Wook Lee, Hwaseong-Si (KR); Tae Woo Lee, Hwaseong-Si (KR)

(73) Assignees: Hyundai Motor Company, Seoul (KR); Kia Corporation, Seoul (KR)

(21) Appl. No.: 18/935,981

(22) Filed: Nov. 4, 2024

(30) Foreign Application Priority Data
Jul. 8, 2024 (KR) 10-2024-0089506

(51) Int. Cl. B60L 15/20

(52) U.S. Cl. CPC B60L 15/20; B60L 2240/16; B60L 2240/423; B60L 2260/28; B60L 2260/44; B60L 2270/145

(57) ABSTRACT

A torque control system for a drive system of an electric vehicle includes a controller that generates a front-wheel torque command and a rear-wheel torque command having torque values distributed from required torque for vehicle driving, a front-wheel motor, wherein operation of the front-wheel motor is controlled according to the front-wheel torque command, and a rear-wheel motor, wherein operation of the rear-wheel motor is controlled according to the rear-wheel torque command. The controller determines whether there is a change request of a direction of the required torque, and determines, in a case where there is the change request of the direction of the required torque, the front-wheel torque command and the rear-wheel torque command determined from the required torque as values for sequential zero-crossing while the required torque determined in real time changes while performing zero-crossing of passing through 0 torque for direction change.

### CROSS-REFERENCE TO RELATED APPLICATION

The present application claims priority to Korean Patent Application No. 10-2024-0089506 filed on Jul. 8, 2024, the entire contents of which is incorporated herein for all purposes by this reference.

### BACKGROUND OF THE PRESENT DISCLOSURE

### Field of the present disclosure

The present disclosure relates to a torque control system for a drive system of an electric vehicle and a method therefor, and more particularly, to a torque control system for a drive system of an electric vehicle and a method therefor, configured for alleviating backlash of the drive system and reducing backlash vibration, improving drivability of the electric vehicle.

### Description of Related art

In general, a vehicle's drive system generates appropriate torque according to a torque command determined by a driver's driving input value such as an accelerator position sensor value or a brake position sensor value, or by a request of an ADAS (Advanced Driver Assistance System).

Here, in a case where a torque change rate (that is, a torque gradient) is set too large, problems such as drive shaft twist, gear backlash shock, or drivability deterioration due to rapid torque change may occur.

In contrast, in a case where the torque change rate is set too small, it takes excessive time to provide torque required by a driver or an ADAS controller, and an actual vehicle behavior may differ from a driver's intention, causing frustrating responsiveness or dangerous situations.

Accordingly, it can be said that there is a conflict between the degree of reduction of Noise, Vibration, and Harshness (NVH) and the degree of acceleration/deceleration responsiveness due to rapid torque change in the vehicle.

In this regard, in mass-produced vehicles, to generate an optimal drive system torque command capable of solving the above-mentioned conflict problem, gradient limits and filters that use various conditions as factors have been used.

In addition, in an electrified vehicle that uses a motor as a drive source or a part thereof, active feedback torque correction control capable of suppressing vibration that has already occurred using the motor may be applied.

However, no matter how advanced backlash post-correction control is, it is difficult to prevent the problem of low responsiveness, which inevitably occurs due to characteristics of hardware. Furthermore, in an electric vehicle with few vibration damping elements in a drive system, NVH issues due to backlash frequently occur.

Generally a method of generating a model speed of a drive shaft using a disturbance observer and reducing vibration using a difference between the model speed of the drive shaft and an actual speed is known. In addition a method of calculating the model speed based on a wheel speed instead of the disturbance observer is generally known.

Furthermore, a method of generating a model speed of a motor using an input torque model and reducing vibration using a difference between the model speed of the motor and an actual speed (measured speed) is known.

In addition, a method of estimating a speed of a drive system using a torque model and determining a gradient of a torque command using a speed difference between the estimated speed and an actual speed of the drive system is known.

However, all of the above-mentioned methods merely disclose a torque post-correction method for reducing and suppressing vibration occurring in the drive system, and do not disclose a torque distribution method and a torque correction method based thereon capable of suppressing or preventing vibration.

The information included in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a torque control system for a drive system and a method therefor, configured for alleviating backlash of the drive system in an electric vehicle and reducing backlash vibration, improving drivability of the vehicle.

In one aspect, the present disclosure provides a torque control system for a drive system of an electric vehicle including a controller that generates a front-wheel torque command and a rear-wheel torque command having torque values distributed from a required torque for vehicle driving, a front-wheel motor operatively connected to the controller, wherein operation of the front-wheel motor is controlled according to the front-wheel torque command generated and output by the controller, and a rear-wheel motor operatively connected to the controller, wherein operation of the rear-wheel motor is controlled according to the rear-wheel torque command generated and output by the controller, in which the controller determines whether there is a change request of a direction of the required torque for the vehicle driving, and determines, in response that the controller concludes that there is the change request of the direction of the required torque, the front-wheel torque command and the rear-wheel torque command determined from the required torque as values for sequential zero-crossing while the required torque determined in real time changes while performing zero-crossing of passing through 0 torque for direction change.

In an exemplary embodiment of the present disclosure, the controller may determine the front-wheel torque command and the rear-wheel torque command determined from the required torque while the required torque changes, as values so that a torque sum of the front-wheel torque command and rear-wheel torque command satisfies the required torque.

In another exemplary embodiment of the present disclosure, the controller may perform torque correction for limiting a change rate of the front-wheel torque command to a preset first maximum allowable change rate in the zero-crossing of the front-wheel torque command, and may perform torque correction for limiting a change rate of the rear-wheel torque command to a preset second maximum allowable change rate in the zero-crossing of the rear-wheel torque command.

In various exemplary embodiments of the present disclosure, the controller may perform, while performing the torque correction for limiting the change rate of the front-wheel torque command to the preset first maximum allowable change rate, torque compensation for the rear-wheel torque command distributed from the required torque so that a sum of the front-wheel torque command, the change rate of which is limited, and the rear-wheel torque command distributed from the required torque satisfies the required torque.

In various exemplary embodiments of the present disclosure, the controller may perform, while performing the torque correction for limiting the change rate of the rear-wheel torque command to the preset second maximum allowable change rate, torque compensation for the front-wheel torque command distributed from the required torque so that a sum of the rear-wheel torque command, the change rate of which is limited and the front-wheel torque command distributed from the required torque satisfies the required torque.

In still various exemplary embodiments of the present disclosure, in the zero-crossing of one of the front-wheel torque command and the rear-wheel torque command, the controller may perform torque correction for limiting a change rate of the torque command of the zero-crossing to a preset change rate, determine a torque correction value based on a backlash estimation value of a drive system where the torque command performs the zero-crossing, and perform torque compensation for compensating for the determined torque correction value with respect to the other torque command without performing the zero-crossing.

In a further exemplary embodiment of the present disclosure, the backlash estimation value may be at least one of a backlash speed estimation value of the drive system where the torque command performs the zero-crossing or a backlash acceleration estimation value of the drive system where the torque command performs the zero-crossing.

In another further exemplary embodiment of the present disclosure, the torque correction value may be determined as a value obtained by multiplying the backlash speed estimation value by a preset gain, a value obtained by multiplying the backlash acceleration estimation value by a preset gain, or a value obtained by summing a value obtained by multiplying the backlash speed estimation value by a preset gain and a value obtained by multiplying the backlash acceleration estimation value by a preset gain.

In yet another further exemplary embodiment of the present disclosure, in the zero-crossing of one of the front-wheel torque command and the rear-wheel torque command, the controller may perform torque correction for limiting a change rate of the torque command performing the zero-crossing to a preset change rate, determine a torque correction value based on a difference between a longitudinal acceleration speed expectation value which is a vehicle longitudinal acceleration estimated based on real-time vehicle driving information in a running vehicle and a vehicle longitudinal acceleration measurement value detected by a longitudinal acceleration sensor, and perform torque compensation for compensating for the determined torque correction value with respect to the other torque command without performing the zero-crossing.

In yet another further exemplary embodiment of the present disclosure, in the zero-crossing of one of the front-wheel torque command and the rear-wheel torque command, the controller may perform torque correction for limiting a change rate of the torque command performing the zero-crossing to a preset change rate, determine a torque correction value based on a difference between a speed expectation value estimated from real-time vehicle driving information in a drive system where the torque command performs the zero-crossing and a speed measurement value of the drive system detected by a speed sensor, and perform torque compensation for compensating for the determined torque correction value with respect to the other torque command without performing the zero-crossing.

In another aspect, the present disclosure provides a torque control method for a drive system of an electric vehicle, including determining whether there is a change request of a direction of required torque for vehicle driving, by a controller, determining, in response that the controller concludes that there is the change request of the direction of the required torque, a front-wheel torque command and a rear-wheel torque command having torque values distributed from the required torque determined in real time while the required torque determined in real time changes while performing zero-crossing of passing through 0 torque to change the direction, by the controller, and controlling operations of a front-wheel motor and a rear-wheel motor according to the determined front-wheel torque command and the determined rear-wheel torque command, by the controller, in which the controller determines the front-wheel torque command and the rear-wheel torque command determined from the required torque as values for sequential zero-crossing while the required torque changes while performing the zero-crossing to change the direction.

The methods and apparatuses of the present invention have other features and advantages which will be apparent from or are set forth in more detail in the accompanying drawings, which are incorporated herein, and the following Detailed Description, which together are configured to explain certain principles of the present invention.

### BRIEF DESCRIPTION OF THE DRAWINGS

FIG. 1 is a block diagram showing a configuration of a system that performs a drive system torque control process according to an exemplary embodiment of the present disclosure;

FIG. 2 is a diagram showing sequential torque direction change of a front-wheel torque command and a rear-wheel torque command according to an exemplary embodiment of the present disclosure;

FIG. 3 is a diagram illustrating an example of sequential torque direction change of a front-wheel torque command and a rear-wheel torque command and gradient limit correction at zero-crossing according to an exemplary embodiment of the present disclosure; and

FIG. 4 is a diagram showing an example of a torque correction value for backlash shock reduction and torque correction using the torque correction value according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. The following specific structural and functional descriptions of embodiments of the present disclosure are merely illustrative for describing the embodiments according to an exemplary embodiment of the present disclosure, and the embodiments according to an exemplary embodiment of the present disclosure may be implemented in various other forms. The present description is not intended to limit the present disclosure to the exemplary embodiments of the present disclosure, and various alternatives, modifications, equivalents and other embodiments should be interpreted as being within the spirit and scope of the present disclosure.

It will be understood that, although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the exemplary embodiments of the present disclosure.

In addition, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other words used to describe the relationship between elements should be interpreted in a similar manner (for example, “between” and “directly between”, “adjacent” and “directly adjacent”, etc.).

Wherever possible, the same reference numbers will be used throughout the drawings to refer to the same or like parts. The terminology used herein is for describing various exemplary embodiments only and is not intended to limit exemplary embodiments of the present disclosure. As used herein, the singular forms “a”, “an”, and “the” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

The present disclosure provides a method for generating a motor torque command and performing drive system torque control, configured for minimizing influence on drivability due to a drive system backlash in an electric vehicle having two or more individual drive motors.

In the present disclosure, in a case where there is a change request of a direction of required torque, control is performed so that a torque direction of a front-wheel drive system and a torque direction of a rear-wheel drive system are sequentially changed, and torque of the front-wheel drive system and torque of the rear-wheel drive system sequentially pass through a backlash band (backlash occurrence torque section).

On the other hand, in typical backlash shock reduction control, in a case where there is a change request of a direction of required torque, control is performed so that a torque direction of a front-wheel drive system and a torque direction of a rear-wheel drive system are changed simultaneously, and in particular, torque of the front-wheel drive system and torque of the rear-wheel drive system achieve zero-crossing while passing through a backlash band at the same time.

Unlike the typical backlash shock reduction control method in which the torque of the front-wheel drive system and the torque of the rear-wheel drive system pass through the backlash band simultaneously, in an exemplary embodiment of the present disclosure, the torque of the front-wheel drive system (referred to as “front-wheel torque”) and the torque of the rear-wheel drive system (referred to as “rear-wheel torque”) sequentially pass through the backlash band.

In particular, in the exemplary embodiments of the present disclosure, in a case where the torque of one of the front-wheel drive system and the rear-wheel drive system performs zero-crossing while passing through the backlash band, torque compensation control is performed on the other drive system to offset the effect, making it possible to prevent backlash of the drive system from affecting the overall acceleration of the vehicle.

That is, in an exemplary embodiment of the present disclosure, by performing torque correction control for alleviating the backlash shock while the torque passes through the backlash band in one of the front-wheel drive system and the rear-wheel drive system, and at the same time, performing control for using the corresponding torque correction amount as a torque compensation amount of the other drive system by only changing the torque direction, it is possible to allow the sum of the front-wheel torque and rear-wheel torque to continuously satisfy the required torque.

In the typical backlash shock reduction control, a correction torque command is determined by subtracting torque corresponding to a backlash shock correction amount in a raw torque command from a torque command passing through a backlash band.

On the other hand, in an exemplary embodiment of the present disclosure, based on a sequential backlash band passage strategy, in a case where a motor torque command (front-wheel torque command or rear-wheel torque command) corresponding to one axle is in the backlash band, the sum of the front-wheel torque command and the rear-wheel torque command is to match the sum of the raw torque commands by adding a torque correction amount obtained by subtracting a motor torque command passing through the backlash band from the raw torque command to a motor torque command corresponding to the other axle.

Additionally, in an exemplary embodiment of the present disclosure, the torque command of an axle that does not pass through the backlash band may be corrected by applying a general backlash compensation torque determination method. In other words, reference variables are set to correct a motor torque command of an axle passing through the backlash band, and the sum of values obtained by multiplying the variable values or derivatives of the variable values by preset weights may be added to a motor torque command of an axle that does not pass through the backlash band.

In addition, based on a longitudinal acceleration sensor measurement value or a drive system speed (motor speed, wheel speed, or the like) measurement value, acceleration/deceleration linearity of the vehicle may be corrected by correcting the motor torque command of the axle that does not pass through the backlash band as much as a difference between the measurement value and an expected value.

By a method for simply correcting the front-wheel torque command and the rear-wheel torque command to follow a raw required torque command value, it is difficult to sufficiently remove acceleration/deceleration nonlinearity (that is, a shortfall or excess between a driver's expected acceleration/deceleration value and occurring shock or an actual acceleration occurrence value).

This is because compliance or backlash shock in the drive system causes change in a longitudinal force component finally transmitted to wheels and a road surface. The acceleration/deceleration nonlinearity resulting from such unmodeled dynamics may be corrected through the above-described methods.

In the present disclosure, the backlash band may be defined as a torque band where a backlash may occur in the vehicle drive system. The vehicle drive system includes drive elements such as a drive unit that drives a vehicle, drive wheels, a drive shaft, a reducer, a differential, and an axle between the drive unit and the drive wheels.

Since problems due to the backlash in the vehicle drive system mainly occur only in a torque band close to 0, it can be said that the torque band close to 0 may be the backlash band where the backlash problems may occur.

In the present disclosure, the backlash band may include a backlash band of the front-wheel drive system, which is a torque band where the backlash may occur in the front-wheel drive system, and a backlash band of the rear-wheel drive system, which is a torque band where the backlash may occur in the rear-wheel drive system.

In the present disclosure, the backlash band of the front-wheel drive system and the backlash band of the rear-wheel drive system may be respectively set to a torque range having a lower limit threshold, which is a negative (−) value, and an upper limit threshold, which is a positive (+) value.

That is, the backlash band may be set to a torque range including 0, and a backlash state may occur in a case where an input torque applied to the drive system from the motor, which is a drive unit, enters the set backlash band.

Here, the backlash refers to a gap that exists between engaged teeth of two gears. Between the two engaged gears, the backlash may cause vibration or noise as the gear teeth strike each other, and in the worst case, the backlash may cause damage to the gears.

In a case where torque is continuously applied in a specific direction, since one of the two engaged gears continues to transmit power in the same direction to the other, the teeth of the two engaged gears remain aligned and engaged in the specific direction, and thus, the backlash problems do not occur.

However, in a case where the direction of the torque changes, the power transmitting direction changes, and the gear teeth are aligned in a reverse direction after experiencing the backlash. Here, after the alignment in the reverse direction is achieved, since the engagement of the gears is not released again while transmitting power in the same direction, the backlash problems do not occur.

However, at the moment when the power transmitting direction changes again, since the engagement between the gears is released and then achieved again after passing through the backlash gap, the backlash problems occur.

In the typical backlash shock reduction control, while the direction of the drive system torque is changed and the drive system torque passes through the backlash band, the torque of the front-wheel drive system and the torque of the rear-wheel drive system pass through the backlash band at the same time.

In the instant case, by performing control for limiting a change rate (gradient) of a torque command of the front-wheel drive system (front-wheel torque command) and a change rate of a torque command of the rear-wheel drive system (rear-wheel torque command), it is possible to prevent the torque commands from rapidly increasing. The backlash control is performed to ensure a smooth torque change within the backlash band for both the front-wheel torque command and the rear-wheel torque command.

To the present end, a maximum allowable change rate in the backlash band for the front-wheel torque command and the rear-wheel torque command may be set to such a small value that does not cause the backlash shock. Accordingly, while the front-wheel torque command and the rear-wheel torque command change and pass through the backlash band, the front-wheel torque command and the rear-wheel torque command may be determined as values that change smoothly according to the maximum allowable change rate (gradient) of the small value.

That is, while passing through the backlash band, the change rates of the front-wheel torque command and the rear-wheel torque command are limited to values equal to or smaller than the maximum allowable change rate, respectively, so that the change rates of the front-wheel torque command and the rear-wheel torque command do not exceed the maximum allowable change rate.

In addition, the front-wheel torque command and the rear-wheel torque command after passing through the backlash band are determined as values that satisfy the torque distributed through the normal front-wheel and rear-wheel torque distribution process.

On the other hand, in an exemplary embodiment of the present disclosure, by allowing the front-wheel torque command and the rear-wheel torque command to sequentially pass through the backlash band, and performing, while one of the front-wheel torque command and the rear-wheel torque command is passing through the backlash band, torque compensation control for offsetting the effect on the other of the front-wheel torque command and the rear-wheel torque command, it is possible to allow the sum of the front-wheel torque command and the rear-wheel torque command to constantly satisfy the required torque, preventing the backlash of the drive system from affecting the overall acceleration of the vehicle.

Hereinafter, a torque control system for a drive system of an electric vehicle and a method therefor according to an exemplary embodiment of the present disclosure will be described in detail.

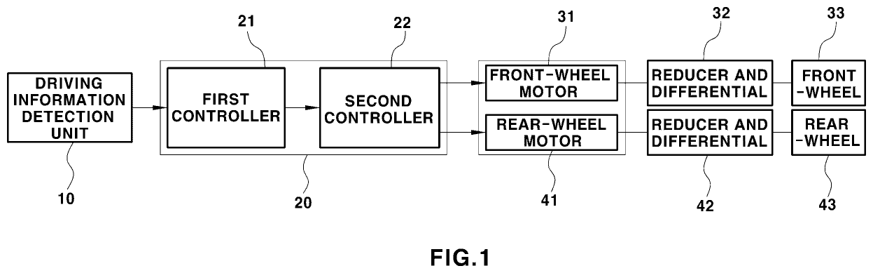

FIG. 1 is a block diagram showing a configuration of a system that performs a drive system torque control process according to an exemplary embodiment of the present disclosure.

The present embodiment may be applied to a vehicle in which front wheels 33 and rear wheels 43 are driven by independent drive units. Specifically, the present embodiment may be applied to a vehicle equipped with a front-wheel drive unit that applies torque to the front wheels 33 and a rear-wheel drive unit that applies torque to the rear wheels 43. Here, the front wheels 33 and the rear wheels 43 are drive wheels connected to the respective drive units to allow power transmission.

In addition, the present embodiment may be applied to a vehicle in which both the front-wheel drive unit and the rear-wheel drive unit are motors. In the following description, a motor 31, which is the front-wheel drive unit, will be referred to as a “front-wheel motor”, and a motor 41, which is a rear-wheel drive unit, will be referred to as a “rear-wheel motor”.

As shown in the figure, the front-wheel motor 31 is connected for power transmission to the front wheels 33 through a reducer and differential 32, and the rear-wheel motor 41 is connected for power transmission to the rear wheels 43 through a reducer and differential 42.

In the following description, a front-wheel torque command and a rear-wheel torque command are axle torque (front axle torque and rear axle torque) commands, which refer to torque commands for the respective motors 31 and 41, that is, a front-wheel motor torque command that is a torque command for the front-wheel motor 31 and a rear-wheel motor torque command that is a torque command for the rear-wheel motor 41, respectively.

In the present embodiment of the present disclosure, among the motor torques, torque in a vehicle acceleration direction and torque in a motor driving direction are defined as positive (+) direction torque, that is, torque with a positive (+) value. In addition, among the motor torques, torque in a vehicle deceleration direction and torque in a motor regenerative direction are defined as negative (−) direction torque, that is, torque with a negative (−) value.

In a case where the torque values of the front-wheel torque command and rear-wheel torque command are positive (+) values, the commands are driving torque commands for the relevant motors, and in a case where the torque values of the front-wheel torque command and rear-wheel torque command are negative (−) values, the commands are regenerative braking torque commands for the relevant motors. The torque value of each command becomes the size of the torque to be generated by the relevant motor according to the command.

As described above, in an exemplary embodiment of the present disclosure, the drive system of the vehicle includes the front-wheel drive system and the rear-wheel drive system, and each of the front-wheel drive system and the rear-wheel drive system includes drive elements such as the motor that drives the vehicle and the drive wheels, the drive shaft between the motor and the drive wheels, the reducer and differential, and the axle.

The front-wheel drive system includes the front-wheel motor 31, the front wheels 33, the drive shaft between the front-wheel motor 31 and the front wheels 33, the reducer and differential 32, the axle, and the rear-wheel drive system includes the rear-wheel motor 41, the rear wheels 43, the drive shaft between the rear-wheel motor 41 and the rear wheels 43, the reducer and differential 42, and the axle.

In each drive system, torque output from the front-wheel motor 31 and the rear-wheel motor 41 may be transmitted to the front wheels 33 and the rear wheels 43 through the drive elements such as the drive shaft, the reducers and differentials 32 and 42, and the axles.

In addition, although not shown in FIG. 1, a battery is connected to the front-wheel motor 31 and the rear-wheel motor 41 via an inverter to enable charging and discharging. The inverter may include a front-wheel inverter for driving and controlling the front-wheel motor 31 and a rear-wheel inverter for driving and controlling the rear-wheel motor 41.

In an electric vehicle, operations (driving and regenerative braking) of the front-wheel motor 31 and the rear-wheel motor 41 are controlled according to torque commands generated by a controller 20. The controller 20 is configured to determine required torque for driving the vehicle based on vehicle driving information acquired by a driving information detection unit 10, or the like, and determines front-wheel torque and rear-wheel torque, which are torques distributed to the front and rear wheels, from the required torque.

Then, the controller 20 uses the determined front-wheel torque and rear-wheel torque as command values to generate and output torque commands for the respective motors, that is, a front-wheel torque command and a rear-wheel torque command, which are torque commands for the respective motors to generate the front-wheel torque and the rear-wheel torque.

Furthermore, the controller 20 is configured to control the operations of the front-wheel motor 31 and the rear-wheel motor 41 through an inverter based on the front-wheel torque command and the rear-wheel torque command. As described above, in a case where the torque values of the front-wheel torque command and the rear-wheel torque command are the positive (+) direction torque (positive value torque), they may be defined as driving torque commands, which are torque commands in the vehicle acceleration direction and driving direction, and in a case where the torque values of the front-wheel torque command and the rear-wheel torque command are the negative (−) direction torque (negative value torque), they may be defined as regenerative braking torque commands, which are torque commands in the vehicle deceleration direction and regenerative direction.

In the present disclosure, the controller 20 may include a first controller 21 that is configured to determine the required torque for the vehicle driving based on vehicle driving information such as driver's driving input values detected by the driving information detection unit 10 or receives the vehicle driving information from another controller such as an ADAS (Advanced Driver Assistance System) controller and generates and outputs the front-wheel torque command and the rear-wheel torque command, which are the torque commands for the respective motors (respective axles), based on the required torque, and a second controller 22 that is configured to control the operations of the front-wheel motor 31 and the rear-wheel motor 41 according to the front-wheel torque command and the rear-wheel torque command output from the first controller 21.

The first controller 21 may be a vehicle control unit (VCU) that determines and generates a torque command necessary for vehicle driving in a typical vehicle. In a general drive mode, since a method for determining required torque for vehicle driving from vehicle driving information and determining a torque command for controlling torque of a drive system including a motor is well-known in the art, a detailed description thereof will be omitted.

In a case where the front-wheel torque command and the rear-wheel torque command are output from the first controller 21, the second controller 22 receives the torque commands, and controls the operations of the front-wheel motor 31 and the rear-wheel motor 41 through the front-wheel inverter and the rear-wheel inverter.

As a result, the torque output from the front-wheel motor 31 is applied to the front wheels 33 through the reducer and differential 32 of the front-wheel drive system, and the torque output from the rear-wheel motor 41 is applied to the rear wheels 43 through the reducer and differential 42 of the rear-wheel drive system.

The second controller 22 may be a typical motor control unit (MCU) that controls an operation of a drive motor through an inverter according to a torque command output from the vehicle control unit (VCU) in the electric vehicle.

In the present disclosure, the vehicle driving information input to the controller 20 is information indicating a vehicle driving status, such as a driver's driving input value, and may include sensor detection information that is detected by the driving information detection unit 10 and is input to the controller 20 through a vehicle network.

Here, the driving information detection unit 10 may include an accelerator position sensor (APS) that detects a driver's accelerator position sensor value (APS value, %), a longitudinal acceleration sensor that detects a longitudinal acceleration of a vehicle, a speed sensor that detects a drive system speed, and a sensor that detects a vehicle speed.

Here, the drive system speed may be a rotation speed of a drive element that is present in a power transmission path from the front-wheel motor 31 or the rear-wheel motor 41 to the corresponding wheels 33 and 43 in the front-wheel drive system or the rear-wheel drive system.

For example, the drive system speed may be a rotation speed of the front-wheel motor 31 and the rear-wheel motor 41, or a rotation speed (wheel speed) of the drive wheels 33 and 43. The speed sensor that detects the drive system speed (drive system speed measurement value to be described later) may be a sensor that detects the rotation speed of each of the motors 31 and 41, which may be a normal resolver that detects a rotor position of the motor. Alternatively, the speed sensor may be a normal wheel speed sensor that detects the rotation speed (wheel speed) of the drive wheels 33 and 43.

The sensor that detects the vehicle speed may also be a wheel speed sensor. Since a method of obtaining vehicle speed information from a signal of the wheel speed sensor is well-known in the art, a detailed description thereof will be omitted.

As the vehicle driving information for determining and generating the required torque and torque command in the controller 20, a driver's accelerator position sensor value (APS value, %), a vehicle's longitudinal acceleration, a rotation speed of the motors 31 and 41, a rotation speed of the drive wheels 33 and 43, a vehicle speed, or the like, which is detected by the driving information detection unit 10, may be selectively used.

Here, in a broad sense, the vehicle driving information may include information determined by the controller 20 itself, and furthermore, may include information (for example, required torque information) input to the controller 20 from another controller (for example, ADAS controller) in the vehicle through the vehicle network.

In the above description, the control subject is divided into the first controller 21 and the second controller 22, but the torque control process according to an exemplary embodiment of the present disclosure may be performed by a single integrated control element instead of the above-described plurality of controllers.

In the present specification, the plurality of controllers 21 and 22 and the single integrated control element may be collectively referred to as the controller 20, and the torque control process according to an exemplary embodiment of the present disclosure may be performed by the controller 20. In the following description, the controller 20 collectively refers to the first controller 21 and the second controller 22 of FIG. 1.

The configuration of the system that performs the drive system torque control process according to an exemplary embodiment of the present disclosure has been described, and hereinafter, the drive system torque control process performed by the above-described system will be described in detail.

In an exemplary embodiment of the present disclosure, the controller 20 is configured to determine required torque for vehicle driving from real-time vehicle driving information detected by the driving information detection unit 10, and then performs front-wheel and rear-wheel torque distribution for following the determined required torque.

In the front-wheel and rear-wheel torque distribution process, the controller 20 is configured to determine the front-wheel torque command and the rear-wheel torque command so that a torque sum of the front-wheel torque command and the rear-wheel torque command (a sum of distributed front-wheel and rear-wheel torque values) is a value for following the required torque.

The controller 20 may distribute required torque received from another controller such as an ADAS controller, instead of the required torque determined by the controller 20 from the vehicle driving information, into front-wheel torque and rear-wheel torque.

Since a method of determining the required torque from the vehicle driving information indicating the driver's driving input value such as an accelerator position sensor value or brake position sensor value, and the vehicle speed, is well known, a detailed description thereof will be omitted.

In a case where the driver tips in an accelerator or tips out the accelerator in the tip-in state, the required torque may switch from vehicle deceleration direction torque to vehicle acceleration direction torque, or vice versa. In the present disclosure, the required torque includes both the vehicle acceleration direction torque and the vehicle deceleration direction torque.

In a case where the direction of the required torque is reversed, the directions of the front-wheel torque and the rear-wheel torque must also be reversed. In the exemplary embodiment of the present disclosure, in a case where there is a change request of the direction of the required torque and a zero-crossing request, the controller 20 sequentially changes the direction of the front-wheel torque (command) and the direction of the rear-wheel torque (command).

More specifically, in an exemplary embodiment of the present disclosure, in a case where the direction of the required torque is to be changed in the opposite direction, that is, in a case where there is a change request of the direction of the required torque, the controller 20 performs control so that the front-wheel torque and the rear-wheel torque sequentially pass through the backlash band (sequential torque direction change).

Here, the fact that the front-wheel torque and the rear-wheel torque are controlled to sequentially pass through the backlash band means that the respective torque commands for controlling the front-wheel motor 31 and the rear-wheel motor 41, that is, the front-wheel torque command and the rear-wheel torque command, are determined to sequentially pass through the backlash band. In the instant case, the two torque commands sequentially perform zero-crossing.

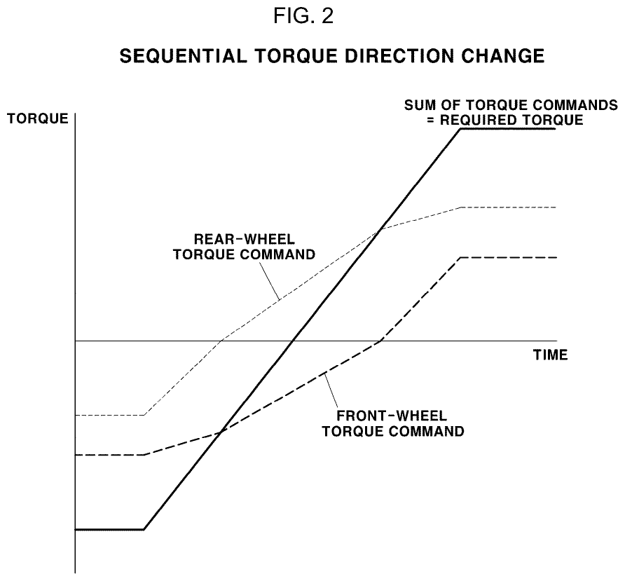

FIG. 2 is a diagram showing sequential torque direction change and zero-crossing of a front-wheel torque command and a rear-wheel torque command in an exemplary embodiment of the present disclosure.

Referring to FIG. 2, in a case where it is determined that there is a change request of the direction of the required torque from the vehicle driving information such as an accelerator position sensor value, the controller 20 performs control so that the front-wheel torque and rear-wheel torque sequentially pass through the backlash band.

In the present disclosure, in a case where it is determined that there is a change request of the direction of the required torque from the vehicle driving information such as an accelerator position sensor value, the controller 20 sequentially determines the front-wheel torque command and the rear-wheel torque command determined from the required torque while the required torque determined in real time changes while performing zero-crossing of passing through 0 torque for the direction change, so that the front-wheel torque and the rear-wheel torque sequentially pass through the backlash band.

In the exemplary embodiment of the present disclosure, the direction change of the front-wheel torque and the rear-wheel torque is performed through the sequential passage of the front-wheel torque and the rear-wheel torque through the backlash band, and the sequential passage of the front-wheel torque (command) and the rear-wheel torque (command) through the backlash band includes a process of sequentially performing the zero-crossing of the front-wheel torque and the zero-crossing of the rear-wheel torque.

In addition, in the exemplary embodiment of the present disclosure, to perform the sequential zero-crossing of the front-wheel torque and the rear-wheel torque, the controller 20 may determine a time point at which the front-wheel torque command performs zero-crossing and a time point at which the rear-wheel torque command performs zero-crossing based on the required torque.

More specifically, in a state where the front and rear-wheel torque distribution ratio is determined as a value corresponding to the required torque by the controller 20, in a case where the front and rear-wheel torque distribution ratio corresponding to a current required torque is determined, the controller 20 may distribute the required torque into the front-wheel torque command and the rear-wheel torque command according to the determined front and rear-wheel torque distribution ratio.

Here, a time point at which the front-wheel torque rate (%) in the front and rear-wheel torque distribution ratio corresponding to the current required torque is 0 may be determined as a zero-crossing point of the front-wheel torque command. Similarly, a time point at which the rear-wheel torque rate (%) in the front and rear-wheel torque distribution ratio corresponding to the current required torque is 0 may be determined as a zero-crossing point of the rear-wheel torque command.

In the present way, in a state in which the required torque with a front-wheel torque distribution rate of 0% and the required torque with a rear-wheel torque distribution rate of 0% are preset in the controller 20, when one of the front-wheel torque command and the rear-wheel torque command that satisfy the required torque has a torque distribution rate of 0% in the current required torque, the controller 20 may determine the time point as the zero-crossing point of the corresponding torque command.

As another exemplary embodiment of the present disclosure, in the sequential zero-crossing process, backlash shock reduction control for limiting a change rate (gradient) of the front-wheel torque command to a predetermined value in the zero-crossing of the front-wheel torque command, and limiting a change rate of the rear-wheel torque command to a predetermined value in the zero-crossing of the rear-wheel torque command may be performed.

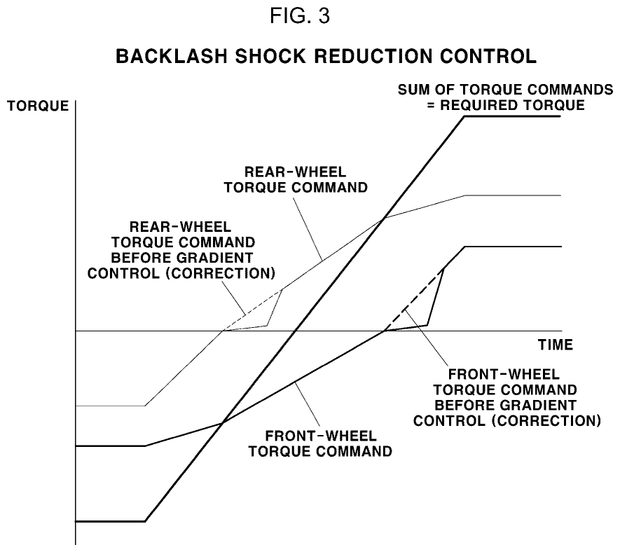

FIG. 3 is a diagram illustrating an example of sequential torque direction change of a front-wheel torque command and a rear-wheel torque command and gradient (change rate) limit correction in zero-crossing according to an exemplary embodiment of the present disclosure.

As shown in FIG. 3, in a case where it is determined that there is a change request of the direction of the required torque from vehicle driving information such as an accelerator position sensor value, the controller 20 performs control so that the front-wheel torque and rear-wheel torque sequentially pass through the backlash band.

Here, in the zero-crossing of the front-wheel torque command, correction is made to limit the change rate (gradient) of the front-wheel torque command to a predetermined maximum allowable change rate (maximum allowable gradient), and in the zero-crossing of the rear-wheel torque command, correction is made to limit the change rate of the rear-wheel torque command to a predetermined maximum allowable change rate. Here, the correction of controlling the change rate of the zero-crossing torque command is correction for backlash shock reduction.

More specifically, in the zero-crossing of the front-wheel torque command, a backlash shock reduction control process of limiting the change rate (gradient) of the distributed front-wheel torque command is performed using a change rate limiter or the like, instead of direct application of the front-wheel torque command that does not take backlash shock into account, that is, the front-wheel torque command distributed and determined from the required torque according to the front and rear-wheel torque distribution logic.

The distributed front-wheel torque command is limited to the preset maximum allowable change rate (first maximum allowable change rate) to be changed smoothly, and accordingly, the front-wheel torque command taking backlash shock into account may be used.

Similarly, in the zero-crossing of the rear-wheel torque command, a backlash shock reduction control process of limiting the change rate (gradient) of the distributed rear-wheel torque command is performed using a change rate limiter or the like, instead of direct application of the rear-wheel torque command that does not take backlash shock into account, that is, the rear-wheel torque command distributed and determined from the required torque according to the front and rear-wheel torque distribution logic.

The distributed rear-wheel torque command is limited to the preset maximum allowable change rate (second maximum allowable change rate) to be changed smoothly, and accordingly, the rear-wheel torque command taking backlash shock into account may be used.

Referring to FIG. 3, it can be seen that the change rate of the front-wheel torque command is limited from a time point at which the front-wheel torque command passes through 0 torque to a time point at which the front-wheel torque command reaches a set torque, and the change rate of the rear-wheel torque command is limited to between a time point at which the rear-wheel torque command passes 0 torque and a time point at which the rear-wheel torque command reaches a set torque.

As another exemplary embodiment of the present disclosure, when one of the front-wheel torque and the rear-wheel torque passes through the backlash band where the change rate is limited, torque compensation control for offsetting the effect of the change rate limit is performed on the other thereof, making it possible to prevent the backlash of the drive system from affecting the overall acceleration of the vehicle.

That is, while limiting the change rate (gradient) of the torque command of one of the front-wheel drive system and the rear-wheel drive system that passes through the backlash band to the set maximum allowable change rate, the torque command of the other drive system is determined as a torque value such that the sum of the two torque commands can satisfy the required torque.

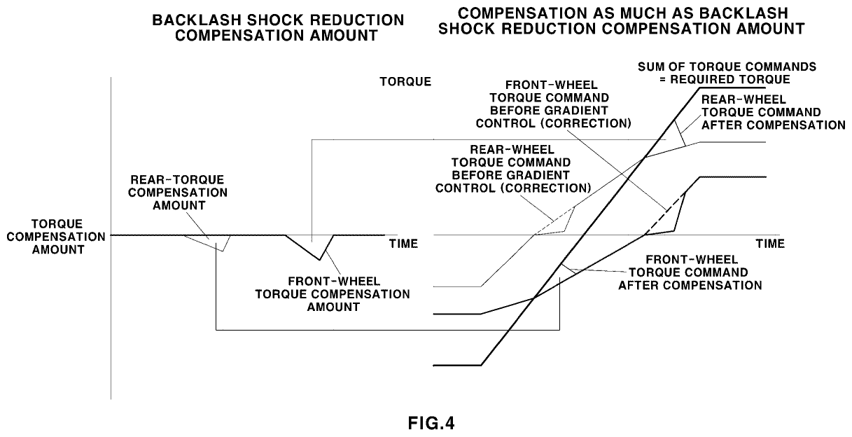

The exemplary embodiment of the present disclosure will be described in more detail with reference to FIG. 4. FIG. 4 is a diagram showing an example of torque correction values (rear-wheel torque compensation amount and front-wheel torque compensation amount) for backlash shock reduction and torque correction using the torque correction values according to an exemplary embodiment of the present disclosure.

In the exemplary embodiment of FIG. 4, as in the exemplary embodiments of FIG. 2 and FIG. 3, the front-wheel torque command and the rear-wheel torque command are controlled to pass through the backlash band sequentially rather than simultaneously.

However, in the exemplary embodiment of FIG. 4, in a case where one of the front-wheel drive system and the rear-wheel drive system passes through the backlash band, that is, in a case where one of the front-wheel torque command and the rear-wheel torque command passes through the backlash band, a torque correction value (in FIG. 4, “rear-wheel torque compensation amount” and “front-wheel torque compensation amount”) is determined using the motor torque command of the drive system passing through the backlash band, and then, the motor torque command of the drive system that does not pass through the backlash band is compensated as much as the torque correction value.

Specifically, in a case where the front-wheel torque command passes through the backlash band to perform zero-crossing, the controller 20 is configured to determine and corrects the change rate (gradient) of the front-wheel torque command to become a value limited to the maximum allowable change rate, and compensates for the rear-wheel torque command with the torque correction value determined using the front-wheel torque command.

In the exemplary embodiment of the present disclosure, the torque correction value (torque compensation amount) refers to the amount of torque corrected by the change rate limit from a raw torque command in a case where the raw torque command distributed from the required torque is corrected by the change rate limit. That is, a difference value between the raw torque command and the torque command corrected by the change rate limit is the torque correction value.

The torque correction value in the zero-crossing of the front-wheel torque command may be determined as a difference value between the front-wheel torque command distributed from the required torque according to the front and rear-wheel torque distribution logic and having no change rate limit (front-wheel torque command that does not take backlash shock into account in FIG. 2), and the front-wheel torque command (front-wheel torque command that takes backlash shock into account in FIG. 3), the torque change rate of which is limited to the maximum allowable change rate.

Accordingly, the front-wheel torque command is determined as a value subjected to the change rate limit, at the same time, compensation is performed for adding the determined torque correction value to the rear-wheel torque command distributed according to the front and rear-wheel torque distribution logic, and the compensated rear-wheel torque command is determined as a final rear-wheel torque command.

Similarly, in a case where the rear-wheel torque command passes through the backlash band to perform zero-crossing, the controller 20 is configured to determine and corrects the change rate (gradient) of the rear-wheel torque command to become a value limited to the maximum allowable change rate, and compensates for the front-wheel torque command with the torque correction value determined using the rear-wheel torque command.

The torque correction value in the zero-crossing of the rear-wheel torque command may be determined as a difference value between the rear-wheel torque command distributed from the required torque according to the front and rear-wheel torque distribution logic and having no change rate limit (rear-wheel torque command that does not take backlash strike into account in FIG. 2), and the rear-wheel torque command (rear-wheel torque command that takes backlash shock into account in FIG. 3), the torque change rate of which is limited to the maximum allowable change rate.

Accordingly, the rear-wheel torque command is determined as a value subjected to the change rate limit, at the same time, compensation is performed for adding the determined torque correction value to the front-wheel torque command distributed according to the front and rear-wheel torque distribution logic, and the compensated front-wheel torque command is determined as a final front-wheel torque command.

In the present way, the controller 20 finally determines the front-wheel torque command and the rear-wheel torque command for backlash shock reduction, enables the sum of the finally determined front-wheel torque command and rear-wheel torque command to follow the required torque, and controls the operations of the front-wheel motor 31 and the rear-wheel motor 41 according to the finally determined front-wheel torque command and rear-wheel torque command.

By constantly satisfying the required torque by the sum of the front-wheel torque and the rear-wheel torque, it is possible to minimize a driving impact due to the backlash in the drive system while the front-wheel torque passes through the backlash band and performs zero-crossing.

In the present way, during the sequential backlash passage and zero-crossing, to prevent torque discontinuity and discontinuity in actual vehicle acceleration from occurring since the sum of the front-wheel torque and rear-wheel torque does not satisfy the required torque, the rear-wheel torque is corrected (that is, compensated by the torque compensation amount) in the zero-crossing of the front wheels, or the front-wheel torque is corrected (that is, compensated by the torque compensation amount) in the zero-crossing of the rear wheels.

The exemplary embodiment in which, in the zero-crossing of the front-wheel torque command, the difference value between the front-wheel torque command, the torque change rate of which is not limited and the front-wheel torque command, the torque change rate of which is limited for the backlash shock reduction is determined as the torque correction value (torque compensation amount), and in the zero-crossing of the rear-wheel torque, the difference value between the rear-wheel torque command, the torque change rate of which is not limited, and the rear-wheel torque command, the torque change rate of which is limited for the backlash shock reduction, is determined as the torque correction value (torque compensation amount), has been described.

In another exemplary embodiment of the present disclosure, in a case where one of the front-wheel torque command and the rear-wheel torque command performs zero-crossing, the backlash shock reduction control is performed to limit the change rate of the motor torque command that performs zero-crossing, and at the same time, a torque correction value is determined during the backlash shock reduction control based on a backlash estimation value of the drive system where the zero-crossing occurs, and then, a motor torque command of the drive system with no-zero crossing (not passing through the backlash band) may be compensated using the determined torque correction value.

That is, whereas the change rate of the front-wheel torque command is limited in the zero-crossing of the front-wheel torque command, after the rear-wheel torque correction value (compensation amount) in the backlash shock reduction control is determined based on the backlash estimation value of the front-wheel drive system, the rear-wheel torque command is compensated using the determined rear-wheel torque correction value.

In addition, whereas the change rate of the rear-wheel torque command is limited in the zero-crossing of the rear-wheel torque command, after the front-wheel torque correction value (compensation amount) in the backlash shock reduction control is determined based on the backlash estimation value of the rear-wheel drive system, the front-wheel torque command is compensated using the determined front-wheel torque correction value.

More specifically, in the zero-crossing of the front-wheel torque command, the controller 20 is configured to determine a backlash estimation value for the front-wheel drive system, determines the rear-wheel torque correction value based on the determined backlash estimation value for the front-wheel drive system, and then compensates for the rear-wheel torque command using the determined rear-wheel torque correction value.

Here, as the backlash estimation value of the front-wheel drive system for determining the rear-wheel torque correction value, a value obtained by multiplying a backlash speed estimation value of the front-wheel drive system or a backlash acceleration estimation value of the front-wheel drive system by a preset gain may be used.

Alternatively, a value obtained by applying a filter and a change rate (gradient) limit to the sum of a value obtained by multiplying the backlash speed estimation value of the front-wheel drive system by a preset gain and a value obtained by multiplying the backlash acceleration estimation value of the front-wheel drive system by a preset gain may be used to determine the rear-wheel torque correction value.

Similarly, in the zero-crossing of the rear-wheel torque command, the controller 20 is configured to determine a backlash estimation value for the rear-wheel drive system, to determine the front-wheel torque correction value based on the determined backlash estimation value for the rear-wheel drive system, and then to compensate for the front-wheel torque command using the determined front-wheel torque correction value.

In the instant case, as the backlash estimation value of the rear-wheel drive system for determining the front-wheel torque correction value, a value obtained by multiplying a backlash speed estimation value of the rear-wheel drive system or a backlash acceleration estimation value of the rear-wheel drive system by a preset gain may be used.

Alternatively, a value obtained by applying a filter and a change rate (gradient) limit to the sum of a value obtained by multiplying the backlash speed estimation value of the rear-wheel drive system by a preset gain and a value obtained by multiplying the backlash acceleration estimation value of the rear-wheel drive system by a preset gain may be used to determine the front-wheel torque correction value.

In the present disclosure, the backlash acceleration estimation value may be obtained by differentiating the backlash speed estimation value. In addition, a method for determining and estimating a backlash speed is generally known, and the backlash speed estimation value in the present disclosure may be determined by the known method.

According to this method, the backlash speed of the front-wheel drive system may be determined from a difference between rotation speeds of the front-wheel motor and the front wheels, and the front-wheel torque command that is the front-wheel motor torque command, and the backlash speed of the rear-wheel drive system may be determined from a difference between rotation speeds of the rear-wheel motor and the rear wheels, and the rear-wheel torque command that is the rear-wheel motor torque command.

As another exemplary embodiment of the present disclosure, based on a difference between a longitudinal acceleration expectation value and a longitudinal acceleration measurement value in a vehicle, a torque correction value (torque compensation amount) to be added to the motor torque command of one of the front-wheel drive system and the rear-wheel drive system that does not pass through the backlash band may be determined.

Here, the longitudinal acceleration expectation value is an estimated longitudinal acceleration of the vehicle, which is estimated based on real-time vehicle driving information collected from the vehicle. The vehicle driving information may include at least one of the accelerator position sensor value detected by the accelerator position sensor, the required torque determined based on the accelerator position sensor value, the drive system speed detected by the speed sensor, or driving road gradient information.

The drive system speed is a rotation speed of a drive element such as a device or part of the drive system, which is provided in a driving power transmission path between the drive unit 30 that drives the vehicle and the drive wheels, which may be a motor speed or a wheel speed, for example. Furthermore, the longitudinal acceleration measurement value (measured longitudinal acceleration) may be detected by a longitudinal acceleration sensor.

In the exemplary embodiment of the present disclosure, in the zero-crossing of the front-wheel torque command, the controller 20 performs the backlash shock reduction control for limiting the change rate of the front-wheel torque command while the front-wheel torque command passes through the backlash band.

At the same time, the controller 20 is configured to determine the rear-wheel torque correction value (rear-wheel torque compensation amount) during the backlash shock reduction control based on the difference between the longitudinal acceleration expectation value (estimated longitudinal acceleration) and the longitudinal acceleration measurement value (measured longitudinal acceleration), and then, corrects the rear-wheel torque command (performs compensation as much as the rear-wheel torque compensation amount) using the determined rear-wheel torque correction value. The final rear-wheel torque command is determined by adding the rear-wheel torque correction value to the rear-wheel torque command distributed from the required torque (performing compensation as much as the rear-wheel torque compensation amount).

Similarly, in the zero-crossing of the rear-wheel torque command, while the rear-wheel torque command passes through the backlash band, the controller 20 performs the backlash shock reduction control for limiting the change rate of the rear-wheel torque command.

At the same time, the controller 20 is configured to determine the front-wheel torque correction value (front-wheel torque compensation amount) during the backlash shock reduction control based on the difference between the longitudinal acceleration expectation value of the vehicle (estimated longitudinal acceleration) and the longitudinal acceleration measurement value (measured longitudinal acceleration), and then, corrects the front-wheel torque command (performs compensation as much as the front-wheel torque compensation amount) using the determined front-wheel torque correction value. The final front-wheel torque command is determined by adding the front-wheel torque correction value to the front-wheel torque command distributed from the required torque (by performing compensation as much as the front-wheel torque compensation amount).

Furthermore, in another exemplary embodiment of the present disclosure, based on a difference between a drive system speed expectation value and a drive system speed measurement value, a torque correction value to be added to a motor torque command of one of the front-wheel drive system and the rear-wheel drive system that does not pass through the backlash band may be determined.

The drive system speed expectation value and the drive system speed measurement value are a speed expectation value (i.e., estimated speed) and a speed measurement value (i.e., measured speed) of the drive system that passes through the backlash band (i.e., zero-crossing). Furthermore, the drive system speed expectation value is an estimated drive system speed, which is a speed estimated based on real-time vehicle driving information collected from the vehicle.

Here, the vehicle driving information may include at least one of the front-wheel torque and rear-wheel torque distributed from the required torque according to the front and rear-wheel torque distribution logic, a rotation speed of another drive element of the drive system detected by the speed sensor, or driving road gradient information.

The rotation speed of the other drive element of the drive system may be, for example, a wheel speed detected by a wheel speed sensor, and in the instant case, the drive system speed expectation value (i.e., estimated drive system speed) may be an estimated motor speed based on an effective gear ratio between the motor and the wheels and the wheel speed detected by the wheel speed sensor.

In addition, the drive system speed is a rotation speed of a drive element such as a device or part of the drive system, which is provided on a driving power transmission path between the drive unit 30 that drives the vehicle and the drive wheels, which may be a motor speed or a wheel speed, for example.

Furthermore, the drive system speed measurement value (measured drive system speed) is a real-time rotation speed measurement value of a drive element such as a device or part of the drive system detected by a speed sensor, which may be a motor speed or a wheel speed detected by a speed sensor.

In the exemplary embodiment of the present disclosure, in the zero-crossing of the front-wheel torque command, the controller 20 performs the backlash shock reduction control for limiting the change rate of the front-wheel torque command while the front-wheel torque command passes through the backlash band.

At the same time, the controller 20 is configured to determine the rear-wheel torque correction value (rear-wheel torque compensation amount) during the backlash shock reduction control based on a difference between a speed expectation value (estimated speed) of the front-wheel drive system and a speed measurement value (measured speed) of the front-wheel drive system, and then, corrects the rear-wheel torque command using the determined rear-wheel torque correction value. The final rear-wheel torque command is determined by adding the rear-wheel torque correction value (rear-wheel torque compensation amount) to the rear-wheel torque command distributed from the required torque.

Similarly, in the zero-crossing of the rear-wheel torque command, the controller 20 performs the backlash shock reduction control for limiting the change rate of the rear-wheel torque command while the rear-wheel torque command passes through the backlash band.

At the same time, the controller 20 is configured to determine the front-wheel torque correction value (front-wheel torque compensation amount) during the backlash shock reduction control based on a difference between a speed expectation value (estimated speed) of the rear-wheel drive system and a speed measurement value (measured speed) of the rear-wheel drive system, and then, corrects the front-wheel torque command distributed from the required torque using the determined front-wheel torque correction value. The final front-wheel torque command is determined by adding the front-wheel torque correction value to the front-wheel torque command distributed from the required torque (by performing compensation as much as the front-wheel torque compensation amount).

In the present way, the torque control system and method for the drive system of the electric vehicle according to the embodiments of the present disclosure have been described in detail. According to the above-described present disclosure, by sequentially changing the directions of the front-wheel torque and the rear-wheel torque, it is possible to alleviate the backlash of the drive system in the electric vehicle, and to reduce the backlash vibration, improving drivability of the vehicle.

In addition, according to an exemplary embodiment of the present disclosure, by solving the backlash shock problem, it is possible to improve the acceleration/deceleration responsiveness and longitudinal driving performance of the vehicle.

In addition, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can also be embodied as computer readable codes on a computer readable recording medium. The computer readable recording medium is any data storage device that can store data which can be thereafter read by a computer system and store and execute program instructions which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code that may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

In addition, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. In addition, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present specification, unless particularly stated otherwise, a singular expression includes a plural expression unless the context clearly indicates otherwise.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A torque control system for a drive system of an electric vehicle, the torque control system comprising:
a controller that generates a front-wheel torque command and a rear-wheel torque command having torque values distributed from a required torque for vehicle driving;
a front-wheel motor operatively connected to the controller, wherein operation of the front-wheel motor is controlled according to the front-wheel torque command generated and output by the controller; and
a rear-wheel motor operatively connected to the controller, wherein operation of the rear-wheel motor is controlled according to the rear-wheel torque command generated and output by the controller,
wherein the controller determines whether there is a change request of a direction of the required torque for the vehicle driving, and determines, in response that the controller concludes that there is the change request of the direction of the required torque, the front-wheel torque command and the rear-wheel torque command determined from the required torque as values for sequential zero-crossing while the required torque determined in real time changes while performing zero-crossing of passing through 0 torque for direction change.

2. The system of claim 1, wherein the controller determines the front-wheel torque command and the rear-wheel torque command determined from the required torque while the required torque changes, as values so that a torque sum of the front-wheel torque command and the rear-wheel torque command satisfies the required torque.

3. The system of claim 1, wherein the controller performs torque correction for limiting a change rate of the front-wheel torque command to a preset first maximum allowable change rate in the zero-crossing of the front-wheel torque command, and performs torque correction for limiting a change rate of the rear-wheel torque command to a preset second maximum allowable change rate in the zero-crossing of the rear-wheel torque command.

4. The system of claim 3, wherein the controller performs, while performing the torque correction for limiting the change rate of the front-wheel torque command to the preset first maximum allowable change rate, torque compensation for the rear-wheel torque command distributed from the required torque so that a sum of the front-wheel torque command, the change rate of which is limited, and the rear-wheel torque command distributed from the required torque satisfies the required torque.

5. The system of claim 3, wherein the controller performs, while performing the torque correction for limiting the change rate of the rear-wheel torque command to the preset second maximum allowable change rate, torque compensation for the front-wheel torque command distributed from the required torque so that a sum of the rear-wheel torque command, the change rate of which is limited, and the front-wheel torque command distributed from the required torque satisfies the required torque.

6. The system of claim 3, wherein, in the zero-crossing of one of the front-wheel torque command and the rear-wheel torque command, the controller performs torque correction for limiting a change rate of the torque command of the zero-crossing to a preset change rate, determines a torque correction value based on a backlash estimation value of the drive system where the torque command performs the zero-crossing, and performs torque compensation for compensating for the determined torque correction value with respect to the other torque command without performing the zero-crossing.

7. The system of claim 6, wherein the backlash estimation value is at least one of a backlash speed estimation value of the drive system where the torque command performs the zero-crossing or a backlash acceleration estimation value of the drive system where the torque command performs the zero-crossing.

8. The system of claim 7, wherein the torque correction value is determined as a value obtained by multiplying the backlash speed estimation value by a preset gain, a value obtained by multiplying the backlash acceleration estimation value by a preset gain, or a value obtained by summing a value obtained by multiplying the backlash speed estimation value by a preset gain and a value obtained by multiplying the backlash acceleration estimation value by a preset gain.

9. The system of claim 3, wherein, in the zero-crossing of one of the front-wheel torque command and the rear-wheel torque command, the controller performs torque correction for limiting a change rate of the torque command performing the zero-crossing to a preset change rate, determines a torque correction value based on a difference between a longitudinal acceleration speed expectation value which is a vehicle longitudinal acceleration estimated based on real-time vehicle driving information in a running vehicle and a vehicle longitudinal acceleration measurement value detected by a longitudinal acceleration sensor operatively connected to the controller, and performs torque compensation for compensating for the determined torque correction value with respect to the other torque command without performing the zero-crossing.

10. The system of claim 3, wherein, in the zero-crossing of one of the front-wheel torque command and the rear-wheel torque command, the controller performs torque correction for limiting a change rate of the torque command performing the zero-crossing to a preset change rate, determines a torque correction value based on a difference between a speed expectation value estimated from real-time vehicle driving information in the drive system where the torque command performs the zero-crossing and a speed measurement value of the drive system detected by a speed sensor operatively connected to the controller, and performs torque compensation for compensating for the determined torque correction value with respect to the other torque command without performing the zero-crossing.

11. A torque control method for a drive system of an electric vehicle, the torque control method comprising:
determining, by a controller, whether there is a change request of a direction of required torque for vehicle driving;
determining, by the controller, in response that the controller concludes that there is the change request of the direction of the required torque, a front-wheel torque command and a rear-wheel torque command having torque values distributed from the required torque determined in real time while the required torque determined in real time changes while performing zero-crossing of passing through 0 torque to change the direction; and
controlling, by the controller, operations of a front-wheel motor and a rear-wheel motor operatively connected to the controller, according to the determined front-wheel torque command and the determined rear-wheel torque command,
wherein the controller determines the front-wheel torque command and the rear-wheel torque command determined from the required torque as values for sequential zero-crossing while the required torque changes while performing the zero-crossing to change the direction.

12. The method of claim 11, wherein the controller determines the front-wheel torque command and the rear-wheel torque command determined from the required torque while the required torque changes, as values such that a torque sum of the front-wheel torque command and rear-wheel torque command that satisfies the required torque.

13. The method of claim 11, wherein the controller performs torque correction for limiting a change rate of the front-wheel torque command to a preset first maximum allowable change rate in the zero-crossing of the front-wheel torque command, and performs torque correction for limiting a change rate of the rear-wheel torque command to a preset second maximum allowable change rate in the zero-crossing of the rear-wheel torque command.

14. The method of claim 13, wherein the controller performs, while performing the torque correction for limiting the change rate of the front-wheel torque command to the preset first maximum allowable change rate, torque compensation for the rear-wheel torque command distributed from the required torque so that a sum of the front-wheel torque command, the change rate of which is limited, and the rear-wheel torque command distributed from the required torque satisfies the required torque.

15. The method of claim 13, wherein the controller performs, while performing the torque correction for limiting the change rate of the rear-wheel torque command to the preset second maximum allowable change rate, torque compensation for the front-wheel torque command distributed from the required torque so that a sum of the rear-wheel torque command, the change rate of which is limited, and the front-wheel torque command distributed from the required torque satisfies the required torque.

16. The method of claim 13, wherein, in the zero-crossing of one of the front-wheel torque command and the rear-wheel torque command, the controller performs torque correction for limiting a change rate of the torque command of the zero-crossing to a preset change rate, determines a torque correction value based on a backlash estimation value of the drive system where the torque command performs the zero-crossing, and performs torque compensation for compensating for the determined torque correction value with respect to the other torque command without performing the zero-crossing.

17. The method of claim 16, wherein the backlash estimation value is at least one of a backlash speed estimation value of the drive system where the torque command performs the zero-crossing or a backlash acceleration estimation value of the drive system where the torque command performs the zero-crossing.

18. The method of claim 17, wherein the torque correction value is determined as a value obtained by multiplying the backlash speed estimation value by a preset gain, a value obtained by multiplying the backlash acceleration estimation value by a preset gain, or a value obtained by summing a value obtained by multiplying the backlash speed estimation value by a preset gain and a value obtained by multiplying the backlash acceleration estimation value by a preset gain.

19. The method of claim 13, wherein, in the zero-crossing of one of the front-wheel torque command and the rear-wheel torque command, the controller performs torque correction for limiting a change rate of the torque command performing the zero-crossing to a preset change rate, determines a torque correction value based on a difference between a longitudinal acceleration speed expectation value which is a vehicle longitudinal acceleration estimated based on real-time vehicle driving information in a running vehicle and a vehicle longitudinal acceleration measurement value detected by a longitudinal acceleration sensor operatively connected to the controller, and performs torque compensation for compensating for the determined torque correction value with respect to the other torque command without performing the zero-crossing.

20. The method of claim 13, wherein, in the zero-crossing of one of the front-wheel torque command and the rear-wheel torque command, the controller performs torque correction for limiting a change rate of the torque command performing the zero-crossing to a preset change rate, determines a torque correction value based on a difference between a speed expectation value estimated from real-time vehicle driving information in the drive system where the torque command performs the zero-crossing and a speed measurement value of the drive system detected by a speed sensor operatively connected to the controller, and performs torque compensation for compensating for the determined torque correction value with respect to the other torque command without performing the zero-crossing.
